(19) United States
(12) Patent Application Publication
(10) Pub. No.: US 2011/0104514 A1
(43) Pub. Date: May 5, 2011

(54) METHOD FOR PRODUCING TINNED STEEL SHEET AND TINNED STEEL SHEET

(75) Inventors: Takeshi Suzuki, Tokyo (JP); Norihiko Nakamura, Tokyo (JP); Hiroki Iwasa, Tokyo (JP)

(73) Assignee: JFE STEEL CORPORATION, Tokyo (JP)

(21) Appl. No.: 13/002,576

(22) PCT Filed: Jul. 2, 2009
(86) PCT No.: PCT/JP2009/062492

§ 371 Date: Jan. 4, 2011

(30) Foreign Application Priority Data
Jul. 4, 2008 (JP) 2008-175184

(51) Int. Cl. B32B 15/01; C25D 7/06

(52) U.S. Cl. 428/648; 205/154

(57) ABSTRACT

A method for producing a tinned steel sheet includes forming an Sn-containing plating layer on at least one surface of a steel sheet such that mass per unit area of Sn is 0.05 to 20 g/m², immersing the steel sheet in a chemical conversion solution which contains greater than 18 to 200 g/L or less of aluminum phosphate monobasic and which has a pH of 1.5 to 2.4 or cathodically electrolyzing the steel sheet at a current density of 10 A/dm² or less in the chemical conversion solution, forming a chemical conversion coating in such a manner that the steel sheet is washed with water and then dried, and forming a product of a reaction with a silane coupling agent such that the mass per unit area is 0.10 to 100 mg/m² in terms of Si.

### RELATED APPLICATIONS

This is a §371 of International Application No. PCT/JP2009/062492, with an inter-national filing date of Jul. 2, 2009 (WO 2010/002038 A1, published Jan. 7, 2010), which is based on Japanese Patent Application No. 2008-175184, filed Jul. 4, 2008, the subject matter of which is incorporated by reference.

### TECHNICAL FIELD

This disclosure relates to tinned steel sheets used for DI cans, food cans, beverage cans, and other cans and particularly relates to a method for producing a tinned steel sheet having a chemical conversion coating, disposed thereon, containing no chromium (Cr) and such a tinned steel sheet.

### BACKGROUND

Tinned steel sheets referred to as “tinplate” have been widely used as surface-treated steel sheets for cans. In the tinned steel sheets, chromate coatings are formed on tin plating layers by chromating in such a manner that steel sheets are immersed in aqueous solutions containing a hexavalent chromium compound such as bichromic acid or are electrolyzed in the aqueous solutions. This is because the formation of the chromate coatings prevents the surface oxidation of the tin plating layers, which are likely to be oxidized during long-term storage, to suppress the deterioration of appearance (yellowing) and also prevents cohesive failure due to the growth of tin (Sn) oxide coatings to secure the adhesion (hereinafter simply referred to as “paint adhesion”) with organic resins such as paints in the case of painting the tinned steel sheets.

In light of recent environmental issues, efforts to restrict the use of Cr are being made in every field. For tinned steel sheets for cans, several chemical conversion techniques alternative to chromating have been proposed.

For example, Japanese Examined Patent Application Publication No. 55-24516 discloses a method for surface-treating a tinned steel sheet. In that method, a chemical conversion coating is formed in such a manner that the tinned steel sheet is subjected to direct-current electrolyzing in a phosphate solution using the tinned steel sheet as a cathode. Japanese Examined Patent Application Publication No. 58-41352 discloses a chemical conversion solution which contains phosphoric ions, tin ions, and one or more of a chlorate and a bromate and which has a pH of 3 to 6. Japanese Unexamined Patent Application No. 49-28539 discloses a method for surface-treating tinplate. In that method, one or more of calcium phosphate, magnesium phosphate, and aluminum phosphate are applied to tinplate to form a coating with a thickness corresponding to 15 μg/cm² or less. Japanese Unexamined Patent Application Publication No. 2005-29808 discloses a surface-treated steel sheet for containers. In the surface-treated steel sheet, an iron-nickel (Fe—Ni) diffusion layer, an Ni layer, an Ni—Sn alloy layer, and a non-alloyed Sn layer are arranged on a surface of a steel sheet in that order and a phosphoric acid coating having a mass per unit area of 1 to 100 mg/m² in terms of phosphorus (P) is disposed on the non-alloyed Sn layer.

The chemical conversion coatings disclosed in JP '516, JP '352, JP '539 and JP '808 are less capable of preventing the deterioration of appearance and reduction of paint adhesion due to the surface oxidation of tin plating layers when compared to conventional chromate coatings.

Japanese Unexamined Patent Application Publication No. 2007-239091 discloses a method for producing a tinned steel sheet. In that method, after a steel sheet is tinned, the tinned steel sheet is immersed in a chemical conversion solution containing tin ions and phosphoric ions or cathodically electrolyzed in the chemical conversion solution and a chemical conversion coating is then formed by heating the tinned steel sheet to a temperature of 60° C. to 200° C., whereby the deterioration of appearance and the reduction of paint adhesion due to the surface oxidation of a tin plating layer can be prevented.

The chemical conversion coating disclosed in JP '091 has performance substantially equal to or better than that of conventional chromate coatings. However, that chemical conversion coating has a problem that the cost of chemical conversion is high because an expensive compound such as stannous chloride, stannic chloride, or tin sulfate is used as a source of tin ions to form this chemical conversion coating and a heating unit used subsequently to chemical conversion is necessary.

It could therefore be helpful to provide a method for producing a tinned steel sheet which is capable of preventing the deterioration of appearance and reduction of paint adhesion due to surface oxidation of a tin plating layer without using Cr and which can be subjected to chemical conversion at low cost and to provide such a tinned steel sheet.

### SUMMARY

We conducted intensive studies on tinned steel sheets which are capable of preventing the deterioration of appearance and the reduction of paint adhesion due to surface oxidation of tin plating layers without using Cr and which can be subjected to chemical conversion at low cost. We found that it is effective that after a chemical conversion coating is formed in such a manner that an Sn-containing plating layer is formed and immersed in a chemical conversion solution which contains aluminum phosphate monobasic and which has a pH of 1.5 to 2.4 or is cathodically electrolyzed in the chemical conversion solution, a product of the reaction with a silane coupling agent is formed.

We thus provide a method for producing a tinned steel sheet that includes forming an Sn-containing plating layer on at least one surface of a steel sheet such that the mass per unit area of Sn is 0.05 to 20 g/m², immersing the steel sheet in a chemical conversion solution which contains greater than 18 to 200 g/L or less of aluminum phosphate monobasic and which has a pH of 1.5 to 2.4 or cathodically electrolyzing the steel sheet at a current density of 10 A/dm² or less in the chemical conversion solution, forming a chemical conversion coating in such a manner that the steel sheet is washed with water and then dried, and then forming a product of the reaction with a silane coupling agent such that the mass per unit area is 0.10 to 100 mg/m² in terms of silicon (Si).

The Sn-containing plating layer is preferably one of a plating layer including a Sn layer and a plating layer including an Fe—Sn layer and a Sn layer deposited thereon. It is preferred that drying be performed at a temperature of lower than 60° C. or cathodic electrolyzing be performed in such a manner that the temperature of the chemical conversion solution is adjusted to 70° C. or higher.

We provide a tinned steel sheet produced by the method.

In the tinned steel sheet, the chemical conversion coating has a mass per unit area of 1.5 to 10 mg/m² in terms of P and the mass ratio (Al/P) of Al to P in the chemical conversion coating is preferably 0.20 to 0.87.

The following sheet can thus be produced: a tinned steel sheet which is capable of preventing the deterioration of appearance and reduction of paint adhesion due to surface oxidation of a tin plating layer without using Cr and which can be subjected to chemical conversion at low cost. The tinned steel sheet is suitable for welded beverage cans, two-piece cans, and other cans, which are required to have particularly high paint adhesion. A chemical conversion coating of a tinned steel sheet can be formed at a high line speed of 300 m/minute or more as is formed by current chromating.

### DETAILED DESCRIPTION

### (1) Formation of Sn-Containing Plating Layer

The following layer is formed on at least one surface of a cold-rolled steel sheet, made of low carbon steel or ultra-low carbon steel, for general cans: an Sn-containing plating layer such as a plating layer (hereinafter referred to as the “Sn layer”) including a Sn layer; a plating layer (hereinafter referred to as the “Fe—Sn/Sn layer”) having a two-layer structure including an Fe—Sn layer and a Sn layer deposited thereon; a plating layer (hereinafter referred to as the “Fe—Sn—Ni/Sn layer”) having a two-layer structure including an Fe—Sn—Ni layer and a Sn layer deposited thereon; or a plating layer (hereinafter referred to as the “Fe—Ni/Fe—Sn—Ni/Sn layer”) having a three-layer structure including an Fe—Ni layer, an Fe—Sn—Ni layer, and a Sn layer, the Fe—Sn—Ni layer and the Sn layer being deposited on the Fe—Sn—Ni layer in that order.

In the Sn-containing plating layer, the mass per unit area of Sn needs to be 0.05 to 20 g/m². This is because when the mass per unit area thereof is less than 0.05 g/m² or greater than 20 g/m², the plating layer is likely to have low corrosion resistance or has an increased thickness to cause an increase in cost, respectively. The mass per unit area of Sn can be determined by coulometry or X-ray fluorescence surface analysis. The Sn-containing plating layer may be a continuous layer or a discontinuous layer in a dotted pattern.

The Sn-containing plating layer can be formed by a known process. The Sn-containing plating layer can be formed by the following procedure: for example, electroplating is performed using an ordinary tin phenolsulfonate plating bath, tin methanesulfonate plating bath, or tin halide plating bath such that the mass per unit area of Sn is 2.8 g/m²; a plating layer including an Fe—Sn layer and a Sn layer is formed in such a manner that reflowing is performed at a temperature not lower than the melting point of Sn, that is, a temperature of 231.9° C. or higher; cathodic electrolyzing is performed in a 10-15 g/L aqueous solution of sodium carbonate at a current density of 1 to 3 A/dm² such that an Sn oxide coating formed on the surface by reflowing is removed; and water-washing is then performed.

An Ni-containing layer which may be included in the Sn-containing plating layer is formed in such a manner that nickel plating is performed prior to tin plating and annealing is then performed as required or reflowing is performed subsequently to tin plating. Hence, a nickel plating unit and complex steps are necessary. Therefore, the Ni-containing layer is higher in cost than Ni-free layers. Thus, the Sn-containing plating layer is preferably an Ni-free layer such as the Sn layer or the Fe—Sn/Sn layer.

### (2) Formation of Chemical Conversion Coating

A chemical conversion coating is formed on the Sn-containing plating layer in such a manner that immersion is performed in a chemical conversion solution which contains greater than 18 to 200 g/L or less of aluminum phosphate monobasic and which has a pH of 1.5 to 2.4 or cathodic electrolyzing is performed at a current density of 10 A/dm² or less in the chemical conversion solution and water washing and then drying are performed.

The reason for using the chemical conversion solution, which contains greater than 18 to 200 g/L or less of aluminum phosphate monobasic, is as described below. When the concentration of aluminum phosphate monobasic is 18 g/L or less, the homogeneous dispersion of Al in the chemical conversion coating is low and the local excess in mass per unit area causes the deterioration of paint adhesion and/or corrosion resistance. When the concentration thereof is greater than 200 g/L, the stability of the chemical conversion solution is low and precipitates are formed in the chemical conversion solution to adhere to a tinned steel sheet, thereby causing the deterioration of appearance and/or the reduction of paint adhesion.

The reason for limiting the pH of the chemical conversion solution to the range of 1.5 to 2.4 is as described below. When the pH thereof is less than 1.5, it is difficult to deposit a coating and a sufficient mass per unit area cannot be achieved even if the time for chemical conversion is significantly increased to several tens of seconds.

When the pH thereof is greater than 2.4, it is difficult to control the mass per unit area because a precipitation reaction occurs quickly during cathodic electrolyzing and the mass per unit area varies significantly with respect to the variation of the current density. The pH thereof can be adjusted by the addition of an acid such as phosphoric acid or sulfuric acid or an alkali such as sodium hydroxide. The chemical conversion solution may further contain an accelerator such as FeCl₂, NiCl₂, FeSO₄, NiSO₄, sodium chlorate, or a nitrite; an etchant such as a fluorine ion; and a surfactant such as sodium lauryl sulfate or acetylene glycol.

Since current chromating is usually performed at a line speed of 300 m/minute or more and extremely high in productivity, novel chemical conversion alternative to chromating can be preferably performed at at least the same line speed as that of current chromating. This is because an increase in treatment time for the chemical conversion requires an increase in the size of a treatment tank and/or an increase in the number of tanks and therefore causes an increase in equipment cost and an increase in maintenance cost. To perform chemical conversion at a line speed of 300 m/minute or more without equipment modification, the treatment time for the chemical conversion is preferably 2.0 seconds or less as is taken for current chromating and more preferably one second or less. To form the chemical conversion coating, immersion or cathodic electrolyzing needs to be performed in the chemical conversion solution. The current density during cathodic electrolyzing needs to be 10 A/dm² or less. This is because when the current density is greater than 10 A/dm², the variation range of the mass per unit area is large with respect to the variation of the current density and therefore it is difficult to stably secure the mass per unit area. Processes such as coating and anodic electrolyzing can be used to form the chemical conversion coating in addition to immersion and cathodic electrolyzing. For coating, uneven surface reactions are likely to occur and therefore uniform appearance is unlikely to be obtained. For anodic electrolyzing, a powdery coating is likely to precipitate and therefore the deterioration of appearance and/or paint adhesion is likely to be caused. Thus, these processes are inappropriate.

After immersion or cathodic electrolyzing is performed, water-washing and drying are performed. Drying is preferably performed at a temperature of lower than 60° C. This is because even if the temperature of drying is lower than 60° C., a producing method can securely prevent the growth of the Sn oxide coating and therefore needs no special heating unit. The reason why the growth of the Sn oxide coating can be securely prevented at a reduced temperature of lower than 60° C. is not necessarily clear, but is probably that the introduction of an Al component into a coating leads to the formation of a complex phosphate coating with high barrier properties. The temperature of the chemical conversion solution is preferably adjusted to 70° C. or higher before cathodic electrolyzing is performed. This is because when the temperature thereof is 70° C. or higher, the rate of deposition increases with an increase in temperature and therefore treatment can be performed at a higher line speed. However, when the temperature thereof is excessively high, the evaporation rate of water from the chemical conversion solution is large and therefore the composition of the chemical conversion solution varies with time. Thus, the temperature of the chemical conversion solution is preferably 85° C. or lower.

The chemical conversion coating, which is formed as described above, preferably has a mass per unit area of 1.5 to 10 mg/m² in terms of P. The mass ratio (Al/P) of Al to P in the chemical conversion coating is preferably 0.20 to 0.87. This is because when the mass per unit area is less than 1.5 mg/m² in terms of P or the mass ratio (Al/P) is less than 0.20, the effect of preventing the surface oxidation of the Sn-containing plating layer is insufficient and the deterioration of appearance and the reduction of paint adhesion are caused. When the mass per unit area is greater than 10 mg/m² in terms of P, cohesive failure occurs in the chemical conversion coating and therefore the paint adhesion thereof is likely to be reduced. The upper limit of the mass ratio (Al/P) is 0.87 and is the maximum stoichiometrically derived from the case where the coating is entirely made of aluminum tertiary phosphate. The mass per unit area in terms of P can be determined by X-ray fluorescence surface analysis. The mass ratio (Al/P) can be determined in such a manner that the mass per unit area of P and that of Al are measured by X-ray fluorescence surface analysis.

To allow the mass per unit area to reach 1.5 to 10 mg/m² in terms of P in a short time, the concentration of aluminum phosphate monobasic is preferably 60 to 120 g/L. To allow the mass per unit area to reach 1.5 to 10 mg/m² in terms of P at a high line speed, cathodic electrolyzing is more preferable than immersion and the pH of the chemical conversion solution is preferably forcibly increased in such a manner that protons located near the interface between the surface of a tin containing plating layer and the chemical conversion solution are consumed by generating gaseous hydrogen by cathodic electrolyzing.

The chemical conversion solution does not contain Sn, which is expensive. Therefore, a method for producing a tinned steel sheet that can be subjected to chemical conversion at low cost can be provided. The chemical conversion coating, which contains Al and P, is unavoidably contaminated with Sn migrating from the Sn-containing plating layer. In this case, the fact remains that substantially the same advantages can be obtained.

### (3) Formation of Product of Reaction of Silane Coupling Agent

Although the deterioration of paint adhesion can be prevented by formation of the Sn-containing plating layer and the chemical conversion coating, a product of the reaction with a silane coupling agent needs to be formed to stably secure good paint adhesion for welded beverage cans, two-piece cans, and other cans, which are required to have higher paint adhesion. The product of the reaction with the silane coupling agent can be formed in such a manner that the steel sheet is immersed in a treating solution of the silane coupling agent, that is, for example, an aqueous solution containing 0.1 to 3 mass percent of the silane coupling agent, such as 3-glycidoxypropyltrimethoxysilane or N-2-(aminoethyl)-3-aminopropyltrimethoxysilane, is wrung with wringer rollers, and then dried at a temperature of 70° C. to 100° C.

The product of the reaction with the silane coupling agent needs to be formed such that the mass per unit area is 0.10 to 100 mg/m² in terms of Si. This is because the coverage of the silane coupling agent is insufficient when the mass per unit area is less than 0.10 mg/m² and also because the silane coupling agent causes cohesive failure and therefore high paint adhesion cannot be achieved when the mass per unit area is greater than 100 mg/m². The mass per unit area in terms of Si can be measured by X-ray fluorescence surface analysis.

### EXAMPLES

The following sheets were used as raw materials:
Steel Sheets A that were low-carbon cold-rolled steel sheets with a thickness of 0.2 mm. Steel Sheets B that were low-carbon cold-rolled steel sheets with a thickness of 0.2 mm, both surfaces of the steel sheets were plated with nickel using a Watts bath to have a mass per unit area of 100 mg/m², and then annealed at 700° C. in an atmosphere containing 10 volume percent H₂ and 90 volume percent N₂, whereby nickel was diffused. After Sn layers were formed using a commercially available tin-plating bath such that the mass per unit area of Sn was as shown in Table 3, the Sn layers were reflowed at a temperature not lower than the melting point of Sn, whereby Sn-containing plating layers each including an Fe—Sn layer and an Sn layer were formed on Steel Sheets A and Sn-containing plating layers each including an Fe—Ni layer, an Fe—Ni—Sn layer, and an Sn layer were formed on Steel Sheets B.

To remove surface Sn oxide coatings formed by reflowing, cathodic electrolyzing was performed at a current density of 1 A/dm² in a 10 g/L aqueous solution of sodium carbonate at a bath temperature of 50° C. After Steel Sheets A and B were washed with water and then cathodically electrolyzed at a current density for a time as shown in Tables 1 and 2 in chemical conversion solution each having an aluminum phosphate monobasic amount, an orthophosphoric acid amount, pH, and temperature shown in Tables 1 and 2, Steel Sheets A and B were wrung with wringer rollers and then dried at room temperature using an ordinary blower whereby chemical conversion coatings were formed.

The pH of each chemical conversion solution shown in Tables 1 and 2 was adjusted by the addition of an acid or an alkali. After the chemical conversion coatings were formed, Sample Nos. 1 to 26 were prepared in such a manner that products of the reaction with silane coupling agents under conditions shown in Tables 1 and 2 using the following solutions except some samples: Treating Solutions a that were 0.004 to 4.0 mass percent aqueous solutions of N-2-(aminoethyl)-3-aminopropyltrimethoxysilane and Treating Solution b that was a 0.2 mass percent aqueous solution of 3-glycidoxypropyltrimethoxysilane.

In Sample No. 13, the chemical conversion coatings were formed in such a manner that immersion was performed for one second in a chemical conversion solution shown in Table 1 instead of cathodic electrolyzing. In Sample No. 12, the chemical conversion solution was dried at 70° C. with hot air without using any blower. In Sample Nos. 23 and 25, no products of the reaction with the silane coupling agents were formed.

After each layer or coating was formed, the mass per unit area of Sn in the Sn-containing plating layers, the mass per unit area of the chemical conversion coatings in terms of P, the mass per unit area of the chemical conversion coatings in terms of Al, the mass ratio (Al/P), and the mass per unit area of the products of the reaction with the silane coupling agents in terms of Si were determined. The tinned steel sheets were evaluated for appearance immediately after production, the amount of the Sn oxide coatings and appearance after long-term storage, paint adhesion, and corrosion resistance by methods below.

Appearance immediately after production: The appearance of each tinned steel sheet was visually observed immediately after production and then evaluated in accordance with standards below. A good appearance was rated as A or B.
A: a good appearance having no surface powdery precipitates and a metallic luster.
B: a good appearance having no surface powdery precipitates and a slightly whitish cast.
C: an uneven appearance having locally present surface powdery precipitates and a slightly whitish cast.
D: a whitish appearance having a large amount of surface powdery precipitates.

Amount of Sn oxide coatings and appearance after long-term storage: Each tinned steel sheet was stored for ten days in an atmosphere having a temperature of 60° C. and a relative humidity of 70%, the appearance thereof was visually observed, the amount of the Sn oxide coatings formed thereon was determined in such a manner that the Sn oxide coatings were electrolyzed at a current density of 25 μA/cm² in a 1/1000 N HBr electrolytic solution and the charge required for electrochemical reduction was determined, and the tinned steel sheet was evaluated in accordance with standards below. A tinned steel sheet having a small amount of Sn oxide coatings and a good appearance after long-term storage was rated as A or B.
A: a reduction charge of less than 2 mC/cm² and an excellent appearance (better than a chromated material).
B: a reduction charge of 2 to less than 3 mC/cm² and a good appearance (substantially equal to a chromated material).
C: a reduction charge of 3 to less than 5 mC/cm² and a slightly yellowish appearance.
D: a reduction charge of 5 mC/cm² or more and a clearly yellow appearance.

Paint adhesion: After the tinned steel sheets were coated with an epoxy-phenolic paint immediately after production such that the mass per unit area thereof was 50 mg/dm², the tinned steel sheets were baked at 210° C. for ten minutes. Two of the coated and baked tinned steel sheets were stacked such that a nylon adhesive film is sandwiched between the coated surfaces thereof. After the two tinned steel sheets were laminated under pressing conditions such as a pressure of 2.94×10⁵ Pa, a temperature of 190° C., and a pressing time of 30 seconds, the laminate was divided into specimens with a width of 5 mm. The specimens were measured for adhesion strength with a tensile tester and then evaluated in accordance with standards below. A tinned steel sheet with good paint adhesion was rated as A. The tinned steel sheets were stored for six months in a room temperature atmosphere and then evaluated for paint adhesion in the same manner as that described above.
A: 19.6 N (2 kgf) or more (substantially equal to a chromated material for welded cans).
B: 3.92 N (0.4 kgf) to less than 19.6 N (substantially equal to a chromated material).
C: 1.96 N (0.2 kgf) to less than 3.92 N.
D: less than 1.96 N (0.2 kgf).

Corrosion resistance: After the tinned steel sheets were coated with an epoxy-phenolic paint such that the mass per unit area thereof was 50 mg/dm², the tinned steel sheets were baked at 210° C. for ten minutes. The tinned steel sheets were immersed in a commercially available tomato juice at 60° C. for ten days and then visually evaluated whether a coating was stripped off and rust was present. A tinned steel sheet having good corrosion resistance was rated as A or B.
A: neither stripped coating nor rust.
B: no stripped coating and a slight number of rust spots (substantially equal to a chromated material).
C: no stripped coating and fine rust spots.
D: stripped coating and rust.

The results are shown in Table 3. Sample Nos. 1 to 18 that are the tinned steel sheets produced by our method each have a good appearance immediately after production and after long-term storage, a small amount of Sn oxide coatings after long-term storage, excellent corrosion resistance, and particularly excellent paint adhesion.

TABLE 1

| | | Chemical conversion coatings | | | | | | | | | | | |
|---|---|---|---|---|---|---|---|---|---|---|---|---|---|
| | Steel | Treating solutions | | | | Cathodic | | | | Products of the reaction with | | | |
| | sheets | Amount of | Amount | | | electrolyzing | | Drying | | silane coupling agents | | | |
| | for | aluminum | of ortho- | | | (immersion) | | | Ultimate | | Concen- | Ultimate | |
| | raw | phosphate | phosphoric | | Temper- | Current | | | temper- | | tration | temper- | |
| Sample | mate- | monobasic | acid | | ature | density | Time | | ature | Treating | (mass | ature | |
| Nos. | rials | (g/L) | (g/L) | pH | (° C.) | (A/dm²) | (s) | System | (° C.) | solutions | percent) | (° C.) | Remarks |
| 1 | A | 19 | 8.5 | 1.74 | 70 | 4 | 1 | Blower | Room | a | 0.3 | 100 | Inventive |
| | | | | | | | | | temperature | | | | example |
| 2 | A | 19 | 4.2 | 1.97 | 70 | 4 | 1 | Blower | Room | a | 0.3 | 100 | Inventive |
| | | | | | | | | | temperature | | | | example |
| 3 | A | 19 | 3.0 | 2.08 | 70 | 4 | 1 | Blower | Room | a | 0.6 | 100 | Inventive |
| | | | | | | | | | temperature | | | | example |
| 4 | A | 54 | 3.0 | 2.12 | 80 | 6 | 1 | Blower | Room | a | 0.3 | 100 | Inventive |
| | | | | | | | | | temperature | | | | example |
| 5 | A | 19 | 20.0 | 1.60 | 70 | 4 | 2 | Blower | Room | a | 0.3 | 100 | Inventive |
| | | | | | | | | | temperature | | | | example |
| 6 | A | 19 | 8.5 | 1.74 | 50 | 4 | 1 | Blower | Room | a | 0.15 | 100 | Inventive |
| | | | | | | | | | temperature | | | | example |
| 7 | A | 60 | 8.5 | 1.80 | 50 | 4 | 0.5 | Blower | Room | a | 0.3 | 100 | Inventive |
| | | | | | | | | | temperature | | | | example |
| 8 | A | 80 | 8.5 | 1.80 | 50 | 4 | 0.5 | Blower | Room | a | 0.3 | 100 | Inventive |
| | | | | | | | | | temperature | | | | example |
| 9 | A | 120 | 8.5 | 1.80 | 50 | 4 | 0.5 | Blower | Room | a | 0.3 | 100 | Inventive |
| | | | | | | | | | temperature | | | | example |
| 10 | A | 200 | 8.5 | 1.80 | 50 | 4 | 0.5 | Blower | Room | a | 0.3 | 100 | Inventive |
| | | | | | | | | | temperature | | | | example |
| 11 | A | 19 | 8.5 | 1.80 | 70 | 4 | 1 | Blower | Room | b | 0.2 | 100 | Inventive |
| | | | | | | | | | temperature | | | | example |
| 12 | A | 60 | 8.5 | 1.80 | 50 | 4 | 0.5 | Hot air | 70 | b | 0.2 | 70 | Inventive |
| | | | | | | | | drying | | | | | example |
| 13 | A | 60 | 8.5 | 1.80 | 70 | Immersion | 0.8 | Blower | Room | a | 0.004 | 100 | Inventive |
| | | | | | | | | | temperature | | | | example |

TABLE 2

| | | Chemical conversion coatings | | | | | | | | | | | |
|---|---|---|---|---|---|---|---|---|---|---|---|---|---|
| | Steel | Treating solutions | | | | Cathodic | | | | Products of the reaction with | | | |
| | sheets | Amount of | Amount | | | electrolyzing | | Drying | | silane coupling agents | | | |
| | for | aluminum | of ortho- | | | (immersion) | | | Ultimate | | Concen- | Ultimate | |
| | raw | phosphate | phosphoric | | Temper- | Current | | | temper- | | tration | temper- | |
| Sample | mate- | monobasic | acid | | ature | density | Time | | ature | Treating | (mass | ature | |
| Nos. | rials | (g/L) | (g/L) | pH | (° C.) | (A/dm²) | (s) | System | (° C.) | olutions | percent) | (° C.) | Remarks |
| 14 | A | 19 | 8.5 | 1.74 | 70 | 5 | 1 | Blower | Room | a | 0.3 | 100 | Inventive |
| | | | | | | | | | temperature | | | | example |
| 15 | B | 19 | 8.5 | 1.74 | 70 | 5 | 1 | Blower | Room | a | 0.3 | 100 | Inventive |
| | | | | | | | | | temperature | | | | example |
| 16 | A | 19 | 8.5 | 1.74 | 70 | 3 | 1 | Blower | Room | b | 0.2 | 70 | Inventive |
| | | | | | | | | | temperature | | | | example |
| 17 | B | 19 | 8.5 | 1.74 | 70 | 3 | 1 | Blower | Room | b | 0.2 | 70 | Inventive |
| | | | | | | | | | temperature | | | | example |
| 18 | A | 80 | 0 | 1.91 | 70 | 4 | 0.5 | Blower | Room | a | 3.0 | 70 | Inventive |
| | | | | | | | | | temperature | | | | example |
| 19 | B | 2 | 8.5 | 1.73 | 70 | 4 | 1 | Blower | Room | a | 0.004 | 100 | Comparative |
| | | | | | | | | | temperature | | | | Example |
| 20 | A | 250 | 8.5 | 2.00 | 70 | 4 | 2 | Blower | Room | a | 0.3 | 100 | Comparative |
| | | | | | | | | | temperature | | | | Example |
| 21 | A | 60 | 8.5 | 1.30 | 85 | 6 | 20 | Blower | Room | a | 0.3 | 100 | Comparative |
| | | | | | | | | | temperature | | | | Example |
| 22 | A | 60 | 8.5 | 2.50 | 50 | 4 | 0.5 | Blower | Room | b | 0.2 | 100 | Comparative |
| | | | | | | | | | temperature | | | | Example |
| 23 | A | 10 | 30.0 | 1.80 | 70 | 4 | 2 | Blower | Room | Not used | | | Comparative |
| | | | | | | | | | temperature | | | | Example |
| 24 | A | * | 6.0 | 2.10 | 60 | 6 | 1 | Blower | Room | a | 0.004 | 100 | Comparative |
| | | | | | | | | | temperature | | | | Example |
| 25 | A | 19 | 8.5 | 2.08 | 70 | 15 | 1 | Blower | Room | Not used | | | Comparative |
| | | | | | | | | | temperature | | | | Example |
| 26 | A | 19 | 8.5 | 1.74 | 70 | 4 | 1 | Blower | Room | a | 4.0 | 100 | Comparative |
| | | | | | | | | | temperature | | | | Example |

*2.7 g/L of SnCl ₄•5H₂O

TABLE 3

| | | | | | Products of | Appear- | Amount | | | | |
|---|---|---|---|---|---|---|---|---|---|---|---|
| | | Chemical conversion coatings | | | reaction of | ance | of Sn | | | | |
| | Sn-containing | Mass per | Mass per | | silane coupling | imme- | oxide | | | | |
| | plating layers | unit area | unit area | | agents | diately | films and | Paint adhesion | | | |
| | Mass per | in terms | in terms | Mass | Mass per unit | after | appearance | Immediately | After | | |
| Sample | unit area of | of P | of Al | ratio | area in terms | prepa- | after long- | after | six | Corrosion | |
| Nos. | Sn (g/m²) | (mg/m²) | (mg/m²) | (Al/P) | of Si (mg/m²) | ration | term storage | preparation | months | resistance | Remarks |
| 1 | 0.8 | 3.20 | 1.70 | 0.53 | 9.0 | A | A | A | A | A | Inventive |
| | | | | | | | | | | | example |
| 2 | 0.8 | 4.50 | 2.39 | 0.53 | 9.0 | A | A | A | A | A | Inventive |
| | | | | | | | | | | | example |
| 3 | 0.8 | 6.50 | 3.45 | 0.53 | 18.0 | A | A | A | A | A | Inventive |
| | | | | | | | | | | | example |
| 4 | 0.8 | 9.50 | 5.13 | 0.54 | 9.0 | B | A | A | A | B | Inventive |
| | | | | | | | | | | | example |
| 5 | 2.8 | 1.80 | 0.97 | 0.54 | 9.0 | A | A | A | A | A | Inventive |
| | | | | | | | | | | | example |
| 6 | 0.8 | 2.50 | 1.38 | 0.55 | 4.5 | A | A | A | A | A | Inventive |
| | | | | | | | | | | | example |
| 7 | 0.8 | 3.00 | 1.62 | 0.54 | 9.0 | A | A | A | A | A | Inventive |
| | | | | | | | | | | | example |
| 8 | 0.8 | 4.00 | 2.20 | 0.55 | 9.0 | A | A | A | A | A | Inventive |
| | | | | | | | | | | | example |
| 9 | 0.8 | 5.00 | 2.85 | 0.57 | 9.0 | A | A | A | A | A | Inventive |
| | | | | | | | | | | | example |
| 10 | 0.8 | 5.10 | 2.96 | 0.58 | 9.0 | A | A | A | A | A | Inventive |
| | | | | | | | | | | | example |
| 11 | 0.8 | 3.20 | 1.70 | 0.53 | 8.0 | A | A | A | A | A | Inventive |
| | | | | | | | | | | | example |
| 12 | 0.8 | 3.00 | 1.62 | 0.54 | 8.0 | A | A | A | A | A | Inventive |
| | | | | | | | | | | | example |
| 13 | 0.8 | 1.80 | 1.40 | 0.78 | 0.1 | A | A | A | A | A | Inventive |
| | | | | | | | | | | | example |
| 14 | 0.8 | 3.30 | 1.75 | 0.53 | 9.0 | A | A | A | A | A | Inventive |
| | | | | | | | | | | | example |
| 15 | 0.8 | 3.40 | 1.77 | 0.52 | 9.0 | A | A | A | A | A | Inventive |
| | | | | | | | | | | | example |
| 16 | 0.1 | 3.60 | 1.94 | 0.54 | 8.0 | A | A | A | A | B | Inventive |
| | | | | | | | | | | | example |
| 17 | 0.1 | 3.70 | 1.96 | 0.53 | 8.0 | A | A | A | A | B | Inventive |
| | | | | | | | | | | | example |
| 18 | 0.1 | 4.10 | 2.21 | 0.54 | 90.0 | A | A | A | A | B | Inventive |
| | | | | | | | | | | | example |
| 19 | 0.8 | 2.50 | 0.45 | 0.18 | 0.1 | A | C | A | C | C | Comparative |
| | | | | | | | | | | | example |
| 20 | 0.8 | 11.00 | 7.59 | 0.69 | 9.0 | D | A | C | C | C | Comparative |
| | | | | | | | | | | | example |
| 21 | 0.8 | 1.40 | 0.74 | 0.53 | 9.0 | A | C | A | B | B | Comparative |
| | | | | | | | | | | | example |
| 22 | 0.8 | 12.00 | 6.72 | 0.56 | 8.0 | C | A | C | C | C | Comparative |
| | | | | | | | | | | | example |
| 23 | 2.8 | 5.40 | 2.86 | 0.53 | 0 | A | A | C | C | C | Comparative |
| | | | | | | | | | | | example |
| 24 | 0.8 | 10.80 | 0 | 0 | 0.1 | B | D | B | D | A | Comparative |
| | | | | | | | | | | | example |
| 25 | 0.8 | 14.00 | 6.58 | 0.47 | 0 | D | A | D | D | D | Comparative |
| | | | | | | | | | | | example |
| 26 | 0.8 | 3.20 | 1.70 | 0.53 | 130 | B | A | C | C | A | Comparative |
| | | | | | | | | | | | example |

### INDUSTRIAL APPLICABILITY

The following sheet can be produced: a tinned steel sheet which is capable of preventing the deterioration of appearance and the reduction of paint adhesion due to the surface oxidation of a tin plating layer without using Cr and which can be subjected to chemical conversion at low cost. A tinned steel sheet is suitable for welded beverage cans, two-piece cans, and other cans, which are required to have particularly high paint adhesion. A chemical conversion coating of a tinned steel sheet can be formed at a high line speed of 300 m/minute or more as is formed by current chromating.

1. A method for producing a tinned steel sheet, comprising:
forming an Sn-containing plating layer on at least one surface of a steel sheet such that mass per unit area of Sn is 0.05 to 20 g/m²;
immersing the steel sheet in a chemical conversion solution which contains greater than 18 to 200 g/L or less of aluminum phosphate monobasic and which has a pH of 1.5 to 2.4 or cathodically electrolyzing the steel sheet at a current density of 10 A/dm² or less in the chemical conversion solution;
forming a chemical conversion coating in such a manner that the steel sheet is washed with water and then dried; and
forming a product of a reaction with a silane coupling agent such that the mass per unit area is 0.10 to 100 mg/m² in terms of Si.

2. The method according to claim 1, wherein the Sn-containing plating layer is one of a plating layer including a Sn layer and a plating layer including an Fe—Sn layer and a Sn layer deposited thereon.

3. The method according to claim 1, wherein drying is performed at a temperature of lower than 60° C.

4. The method according to claim 1, wherein cathodic electrolyzing is performed such that the temperature of the chemical conversion solution is adjusted to 70° C. or higher.

5. A tinned steel sheet produced by the method according to claim 1.

6. The tinned steel sheet according to claim 5, wherein the chemical conversion coating has a mass per unit area of 1.5 to 10 mg/m² in terms of P and the mass ratio (Al/P) of Al to P in the chemical conversion coating is 0.20 to 0.87.

7. The method according to claim 2, wherein drying is performed at a temperature of lower than 60° C.

8. The method according to claim 2, wherein cathodic electrolyzing is performed such that the temperature of the chemical conversion solution is adjusted to 70° C. or higher.

9. The method according to claim 3, wherein cathodic electrolyzing is performed such that the temperature of the chemical conversion solution is adjusted to 70° C. or higher.

10. The method according to claim 7, wherein cathodic electrolyzing is performed such that the temperature of the chemical conversion solution is adjusted to 70° C. or higher.

11. A tinned steel sheet produced by the method according to claim 2.

12. A tinned steel sheet produced by the method according to claim 3.

13. A tinned steel sheet produced by the method according to claim 4.

14. The tinned steel sheet according to claim 11, wherein the chemical conversion coating has a mass per unit area of 1.5 to 10 mg/m² in terms of P and the mass ratio (Al/P) of Al to P in the chemical conversion coating is 0.20 to 0.87.

15. The tinned steel sheet according to claim 12, wherein the chemical conversion coating has a mass per unit area of 1.5 to 10 mg/m² in terms of P and the mass ratio (Al/P) of Al to P in the chemical conversion coating is 0.20 to 0.87.

16. The tinned steel sheet according to claim 13, wherein the chemical conversion coating has a mass per unit area of 1.5 to 10 mg/m² in terms of P and the mass ratio (Al/P) of Al to P in the chemical conversion coating is 0.20 to 0.87.
